(19) United States
(12) Patent Application Publication
(10) Pub. No.: US 2026/0302009 A1
(43) Pub. Date: Oct. 1, 2026

(54) LOW VOC COATING FOR HIGH-TEMPERATURE MOVS

(71) Applicant: Dongguan Littelfuse Electronics Company Limited, Dongguan City (CN)

(72) Inventors: Hao Cheng, Dongguan City (CN); Gao Huang, Dongguan City (CN); Shuying Liu, Dongguan City (CN); Jianhua Chen, Sunnyvale, CA (US)

(73) Assignee: Dongguan Littelfuse Electronics Company Limited, Dongguan City, GD (CN)

(21) Appl. No.: 19/656,365

(22) Filed: Apr. 23, 2026

(30) Foreign Application Priority Data
Mar. 31, 2025 (CN) 202520597837.2

(51) Int. Cl. H01C 7/12

(52) U.S. Cl. CPC H01C 7/12

(57) ABSTRACT

A protection device may include a varistor body an inner layer formed directly atop a first main side and a second main side the varistor body. The protection device may further include an exterior layer formed directly atop the inner layer, wherein the exterior layer is harder than the inner layer.

### CROSS-REFERENCE TO RELATED APPLICATIONS

This application claims the benefit of priority to, Chinese Utility Model Application No. 202520597837.2, filed Mar. 31, 2025, entitled “Low VOC Coating for High-Temperature MOVs,” which application is incorporated herein by reference in its entirety.

### FIELD OF THE DISCLOSURE

The disclosure relates generally to the protection of electrical and electronic circuits and equipment from power surges and, more particularly, to a next generation low VOC, high temperature coating solution for MOV and other radial chips.

### BACKGROUND OF THE DISCLOSURE

Over-voltage protection devices are used to protect electronic circuits and components from damage due to over-voltage fault conditions. These over-voltage protection devices may include metal oxide varistors (MOVs) that are connected between the circuits to be protected, and a ground line. MOVs have a specific current-voltage characteristic that allows them to be used to protect such circuits against catastrophic voltage surges. In particular, when a voltage that is larger than the nominal or threshold voltage is applied to the device, current flows through an MOV, which generates heat. This causes the linking element to melt. Once the link melts, an open circuit is created, which prevents the MOV from catching fire.

MOVs include a coating to protect the internal components thereof. An epoxy is one typical material. However, epoxy is limited to lower temperature applications (e.g., less than 85 or 105° C.), and has inadequate humidity and temperature cycling test (TCT) performance. Other materials used in high temperature MOVs are silicone resin and phenolic. Although these coating materials have improved TCT performance, they involve a high solvent content (e.g. approximately 32%) and, therefore, a large amount of VOC discharge.

It is with respect to these and other drawbacks that the current disclosure is provided.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In some embodiments, a protection device may include a varistor body, and an inner layer surrounding the varistor body. The protection device may further include an exterior layer over the inner layer, wherein the exterior layer is harder than the inner layer.

In some embodiments, a metal oxide varistor (MOV) device may include a varistor body, and an inner layer formed directly atop a first main side and a second main side of the varistor body. The MOV may further include an exterior layer formed directly atop the inner layer, wherein the exterior layer is harder than the inner layer.

In some embodiments, a method of coating a metal oxide varistor (MOV) device may include forming an inner layer directly atop a first main side and a second main side of a varistor body, and then forming an exterior layer directly atop the inner layer, wherein the exterior layer is harder than the inner layer.

### BRIEF DESCRIPTION OF THE DRAWINGS

The accompanying drawings illustrate exemplary approaches of the disclosed embodiments so far devised for the practical application of the principles thereof, and in which:

FIG. 1A depicts a top view of an MOV device according to embodiments of the present disclosure;

FIG. 1B depicts a cross-sectional view of the MOV of FIG. 1A according to embodiments of the present disclosure;

FIG. 2A depicts a top view of the MOV device according to embodiments of the present disclosure; and

FIG. 2B depicts a cross-sectional view of the MOV of FIG. 2A according to embodiments of the present disclosure.

The drawings are not necessarily to scale. The drawings are merely representations, not intended to portray specific parameters of the disclosure. The drawings are intended to depict typical embodiments of the disclosure, and therefore should not be considered as limiting in scope. In the drawings, like numbering represents like elements.

Furthermore, certain elements in some of the figures may be omitted, or illustrated not-to-scale, for illustrative clarity. Cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

Protection devices in accordance with the present disclosure will now be described more fully hereinafter with reference to the accompanying drawings, in which embodiments of the system and method are shown. The protection devices, however, may be embodied in many different forms and should not be construed as being limited to the embodiments set forth herein. Rather, these embodiments are provided so that this disclosure will be thorough and complete, and will fully convey the scope of the system and method to those skilled in the art.

As will be described herein, embodiments of the present disclosure are directed to a next generation low-VOC, high-temperature coating solution for MOV and other radial chips. More specifically, the present disclosure describes a “two-layer” design. The inner layer is soft, which helps relieve TCT thermal stress and enables the two-layer coated device to pass the 1000-cycle TCT test without visual defects (e.g., coating cracks). Only a limited number of coating materials, such as silicone resin, phenolic resin, and silicone rubber, pass the 1000-cycle TCT test. Among these, silicone rubber is an appropriate low or no VOC option.

However, silicone rubber materials are inherently soft, which explains their effectiveness in stress relief. This softness has also received criticism when the material is used as a protective coating independently. There are other materials that can pass both the 1000-cycle TCT test and other reliability tests, such as the 8585 bias humidity, 125° C. loading, and 150° C. storage tests. For example, plastic materials like liquid crystal polymers (LCP), which utilize an injection molding process, can meet these criteria. However, the very high cost of materials and processes prevents their large-scale application in MOV products.

The exterior layer, such as epoxy, possesses good mechanical strength and can withstand scratching, dropping, and other mechanical impacts during shipping, assembly, and other processes. While the hard exterior layer (like epoxy) typically exhibits poor performance in TCT and bias humidity tests, it cannot be used alone for high-temperature materials. This is why the two-layer design is proposed in this disclosure. To meet long-term EHS goals, low or no VOC materials are preferred for both the inner and exterior layers. Moreover, the inner and exterior layers should be properly designed and selected to match each other and prevent failure modes, such as delamination, during the aforementioned key environmental reliability tests.

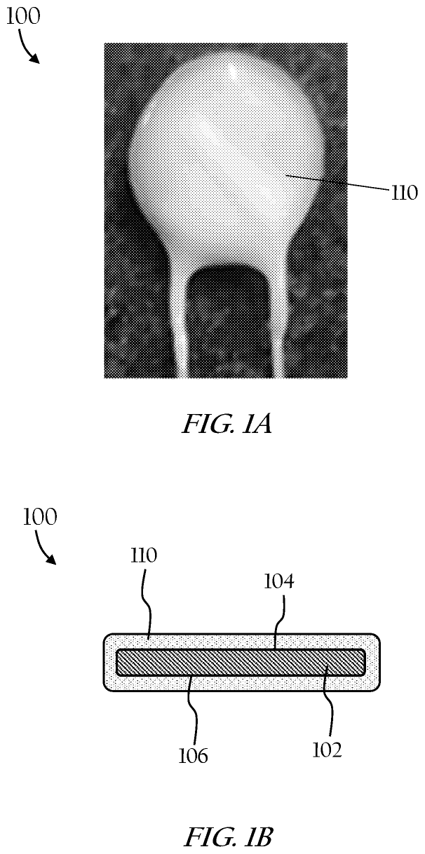

Turning now to FIG. 1A-1B, a MOV device (hereinafter “device”) 100 according to embodiments of the disclosure will be described in greater detail. As shown, the device 100 may include a varistor body 102, which in this embodiment has circular or disc-like shape. The varistor body 102 may include a first main side 104 opposite a second main side 106. A first terminal is electrically connected to the thermal electrode along the first main side 104, while a second terminal is electrically connected to the electrode along the second main side 106.

The device 100 may further include an inner layer 110 surrounding the varistor body 102. More specifically, the inner layer 110 may be conformally formed over all sides of the varistor body 102, including directly atop the first and second main sides 104, 106 thereof. In some embodiments, the inner layer 110 may be a room temperature vulcanized (RTV) silicone rubber or other soft UL cured material(s). The inner layer 110 may include no solvent, and may be considered low-VOC, i.e., contain less than 50 grams per liter of volatile organic compounds. In an alternative embodiment, the inner layer 110 may include multiple layers.

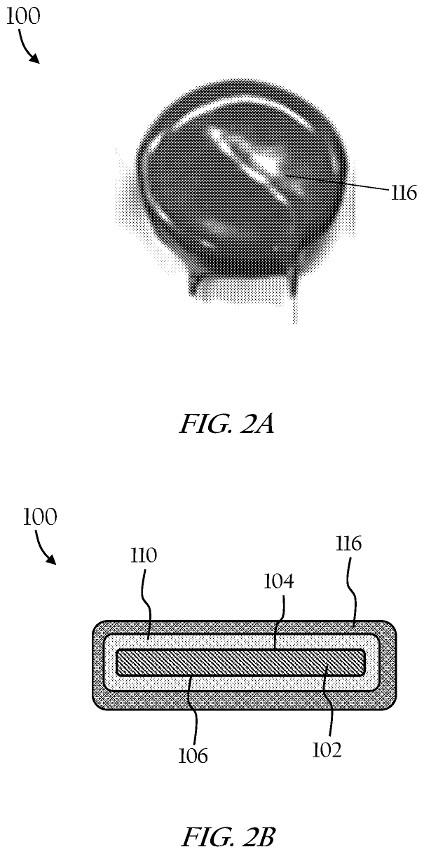

As shown in FIG. 2A-2B, the device 100 may further include an exterior layer 116 surrounding the inner layer 110 and the varistor body 102. More specifically, the exterior layer 116 may be conformally formed directly over all sides of the inner layer 110. In some embodiments, the exterior layer 116 may be epoxy, silicone resin, nylon, polyphenylene sulfide, or liquid crystal polymer. The exterior layer 116 may include no solvent, and may be considered low-VOC. The exterior layer 116 is harder than the inner layer 110.

In sum, embodiments herein provide a multilayer inner coating design including an exterior coating over the multilayer inner coating. The inner layer(s) is soft and used as a stress release layer to enable the coating combination to pass 1000 cycle TCT. The hard outer layer is used to prevent damage of soft layer during transportation, handling, and MOV assembly on PCB board. Both inner layer and outer layer materials are low/no VOC materials, without solvent inside. Furthermore, this novel coating design can pass critical environmental test without damage, for example, tests like bias humidity, loading, high-T storage, and TCT.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, the present disclosure has been described herein in the context of a particular implementation in a particular environment for a particular purpose. Those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A protection device, comprising:
a varistor body;
an inner layer surrounding the varistor body; and
an exterior layer over the inner layer, wherein the exterior layer is harder than the inner layer.

2. The protection device of claim 1, wherein the inner layer is made from a silicon rubber without solvent.

3. The protection device of claim 1, wherein the exterior layer is made from one of the following: epoxy, silicone resin, nylon, polyphenylene sulfide, and liquid crystal polymer.

4. The protection device of claim 1, wherein the inner layer and the exterior layer contain less than 50 grams per liter of volatile organic compounds.

5. The protection device of claim 1, wherein the varistor body is a metal oxide varistor body.

6. A metal oxide varistor (MOV) device, comprising:
a varistor body;
an inner layer formed directly atop a first main side and a second main side of the varistor body; and
an exterior layer formed directly atop the inner layer, wherein the exterior layer is harder than the inner layer.

7. The protection device of claim 6, wherein the inner layer is made from a silicon rubber without solvent.

8. The protection device of claim 6, wherein the exterior layer is made from one of the following: epoxy, silicone resin, nylon, polyphenylene sulfide, and liquid crystal polymer.

9. The protection device of claim 6, wherein the inner layer and the exterior layer contain less than 50 grams per liter of volatile organic compounds.
